(19) United States
(12) Patent Application Publication
(10) Pub. No.: US 2010/0114726 A1
(43) Pub. Date: May 6, 2010

(54) SOCIAL DISCOVERY OF DIGITAL CONTENT

(75) Inventors: Tricia Lee, Kirkland, WA (US); Jason Aaron Gold, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/262,597

(22) Filed: Oct. 31, 2008

(51) Int. Cl. G06Q 30/00; G06Q 50/00

(52) U.S. Cl. 705/26

(57) ABSTRACT

Shopping for digital content may be facilitated by offering to a shopper a plurality of digital content items available for acquisition via a network-accessible virtual storefront. Further, for a digital content item selected within the network-accessible virtual storefront, one or more shopper-confirmed friends having a usage history with the selected digital content item can be identified.

### BACKGROUND

Digital content such as music, movies, podcasts, and games can be made available for sale, rent, subscription and various other modes of consumption. However, there is a vast amount of digital content available for consumption. As a result, it can be difficult for a shopper to efficiently identify content that is of interest to the shopper, and even once identified, it can be difficult for the shopper to acquire such digital content.

### SUMMARY

Social discovery and connection while a shopper is browsing his/her local digital content and shopping for digital content is described herein. Shopping for digital content may be facilitated by offering to the shopper a plurality of digital content items available for acquisition via a network-accessible virtual storefront. Further, for a digital content item selected within the network-accessible virtual storefront, one or more shopper-confirmed friends having a usage history with the selected digital content item may be identified.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example digital content management system.

FIG. 2 shows an example screen of a graphical user interface displaying a user's digital content library.

FIG. 3 shows an example screen of a graphical user interface displaying a network-accessible virtual storefront including mini virtual-identity cards for user-confirmed friends and other unconfirmed users.

FIG. 4 shows an example screen of a graphical user interface displaying the network-accessible virtual storefront including a virtual-identity card for a user-confirmed friend.

FIG. 5 shows an example screen of a graphical user interface of the network-accessible virtual storefront.

FIG. 6 shows an example method of selling or renting digital content to a shopper.

FIG. 7 shows an example method of selling or renting digital content to a shopper.

### DETAILED DESCRIPTION

Social discovery and connection while browsing local digital content and shopping for digital content is provided. An example method of selling or renting digital content to a shopper may include offering to the shopper a plurality of digital content items available for acquisition via a network-accessible virtual storefront. Further, the method may include identifying, for a digital content item selected within the network-accessible virtual storefront, one or more shopper-confirmed friends having a usage history with that selected digital content item.

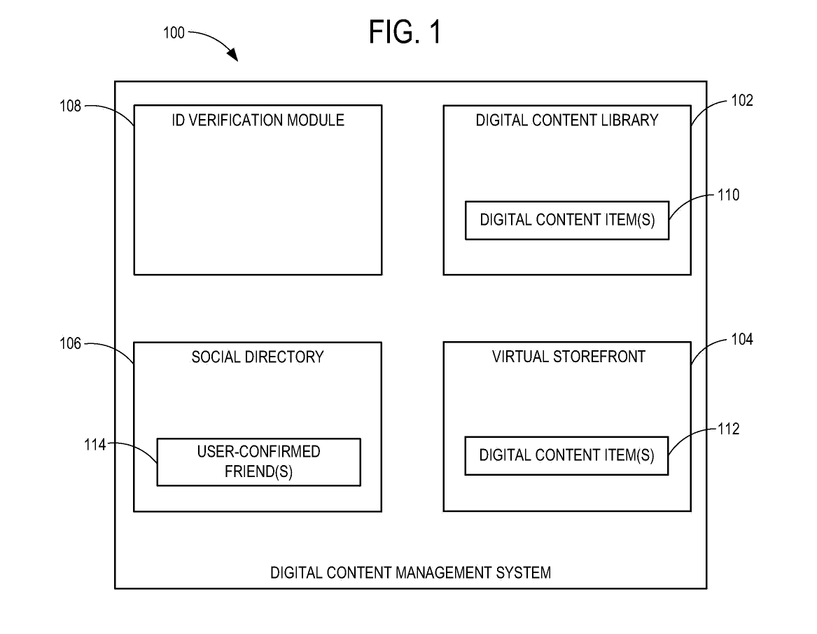

FIG. 1 schematically shows a digital content management system 100. The digital content management system 100 may include a digital content library 102, a network-accessible virtual storefront 104, a network-accessible social directory 106, and an identification verification module 108.

The digital content library 102 may include (i.e., provide access to) a plurality of locally-saved digital content items 110 previously acquired by a user (e.g., a shopper). For example, the user may have downloaded songs and podcasts from the Internet, ripped music from a CD, and/or uploaded video from a camcorder and stored such audio and video files as digital content items 110 in one or more media storage devices (e.g., hard drive in personal computer, network-accessible storage, etc.), such digital content items 110 being catalogued and made accessible via the digital content library 102.

The network-accessible virtual storefront 104 may include a plurality of digital content items 112 available for acquisition by the user. For example, the network-accessible virtual storefront 104 may offer audio files, video files, and other products and services for sale, rent, preview, and/or subscription. If the user purchases a file from the network-accessible virtual storefront 104, it can be added to the digital content library 102 as one of the digital content items 110.

Further, the digital content management system 100 may include a network-accessible social directory 106 including a plurality of user-confirmed friends 114. For example, the network-accessible social directory 106 may allow the user to invite other users and accept invitations from other users to be friends. As will be described herein, user-confirmed friends may help the user to socially discover music, videos, and other products or services that the user may be interested in previewing and/or purchasing.

As illustrated, the digital content management system 100 may further include an identification verification module 108 that commonly limits acquisition access to the network-accessible virtual storefront 104 and directory access to the network-accessible social directory 106. Limits imposed by the identification verification module 108 may be contingent on verification of a common credential. In one example, this credential may include a username and password. Thus, when a user wants to purchase a file, for example, from the network-accessible virtual storefront 104, that user may be asked to login with a username and password. The same username and password may be used to gain access to the directory of user-confirmed friends 114 in the network-accessible social directory 106. In other words, by logging on a single time with the same username and password, a user may have full access to both the network-accessible virtual storefront 104 and the network-accessible social directory 106. The network-accessible social directory 106 and the network-accessible virtual storefront 104 are protected by a shared identity-verification module 108.

The digital content library 102, the network-accessible virtual storefront 104, and the network-accessible social directory 106 may be accessible via a same locally executed set of instructions, such as a software package, configured to present a shared graphical user interface. As some examples, the user may download the software package to a local device, operate the software remotely from another device accessible via a local area network, and/or run the software as a network service.

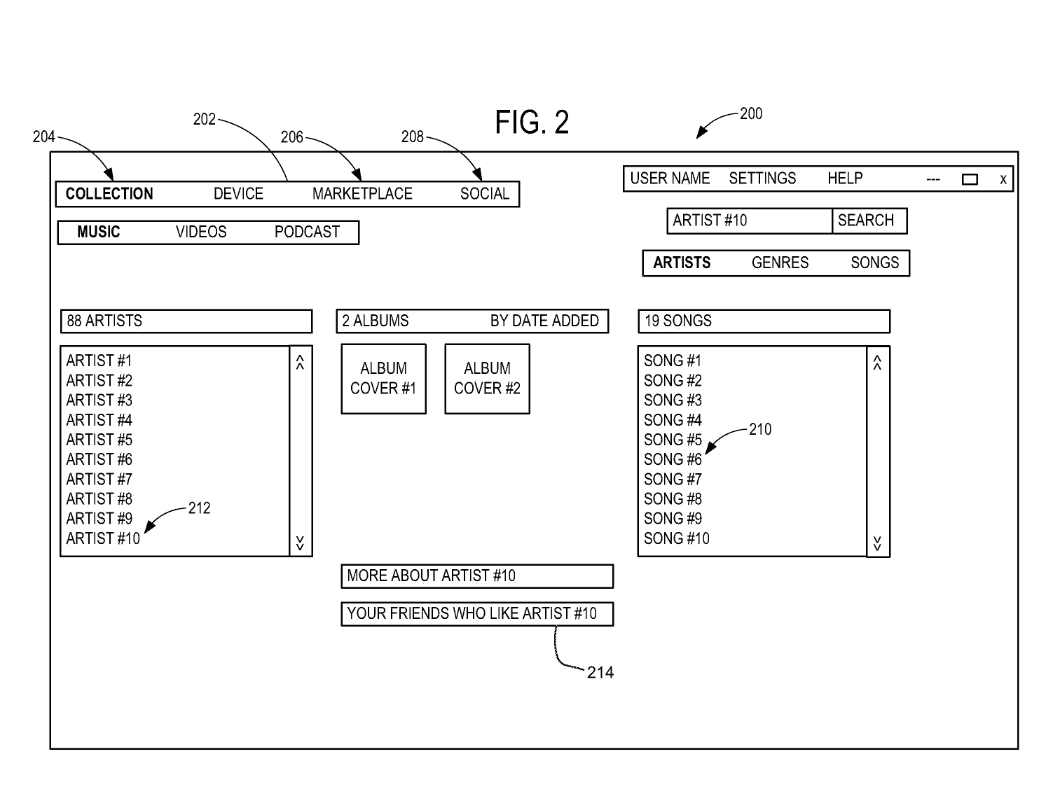

Schematic views of example screens of the graphical user interface are illustrated in FIGS. 2-5. For example, in FIG. 2, an example screen 200 including a navigation pane 202 for navigating between different screens of a shared graphical user interface is illustrated. For example, a collection button 204, a marketplace button 206, and a social button 208 may be selected to navigate between different screens of the shared graphical user interface. In one example, if a selection of the collection button 204 is received, a digital content management system may present a screen of a user's digital content library. In another example, if a selection of the marketplace button 206 is received, a digital content management system may present a screen of a network-accessible virtual storefront. In yet another example, if a selection of the social button 208 is received, a digital content management system may present a screen of a network-accessible social directory. In the example screens depicted in FIGS. 2-5, the selected button of the example screen is indicated by bold letters. Thus, the bold letters indicate whether the example screen is displaying a user's digital content library, a network-accessible virtual storefront, or a network-accessible social directory.

FIG. 2 thus shows a non-limiting example screen 200 of a graphical user interface displaying a user's digital content library. In this example, a plurality of digital content items (e.g., audio files, video files, etc.) previously acquired may be presented to the user. A digital content library may be sorted by artist, genre, album name, and/or song name, as some examples. The screen 200 may be designed to receive user input such that, in one example, if a selection of a song selection link 210, associated with the digital content item titled “Song #6” by the artist indicated at an artist selection link 212 (e.g., “Artist #10) is received, a digital content management system may identify one or more user-confirmed friends having a usage history with the digital content item associated with the selected song selection link 210. As used herein, a usage history may include a user playing a digital content item within a threshold duration or above a threshold number of times, marking a digital content item as a favorite, purchasing a digital content item, recommending a digital content item, including a digital content item in a playlist or other selected set of digital content items, and/or otherwise demonstrating an interest in the digital content item.

User-confirmed friends may be identified as described above upon selection of a song, artist, album, and/or virtually any other category for which user-confirmed friends have a usage history. Further, a friend link 214 may be presented to provide access to virtual-identity cards for such user-confirmed friends. As used herein, virtual identity cards may be visual representations of one or more aspects of a user-confirmed friend or an unconfirmed user. Virtual identity cards may include a username, real name, photograph, avatar, identification information, content recommendations, information regarding recently played content for that user, links to more complete user profiles, and/or other information relating to that user.

In another example, if a selection of an artist selection link 212 is received, a digital content management system may identify one or more user-confirmed friends having a usage history with digital content items associated with the artist indicated at artist selection link 212 (e.g., “Artist #10). Further, a friend link 214 may be presented to provide access to virtual-identity cards for such user-confirmed friends. A usage history may include having listened to an artist (e.g., Artist #10) a predetermined number of times, having listened to an artist in a predetermined period of time (e.g., in the last week), and/or having indicated an artist as a favorite artist, as some examples.

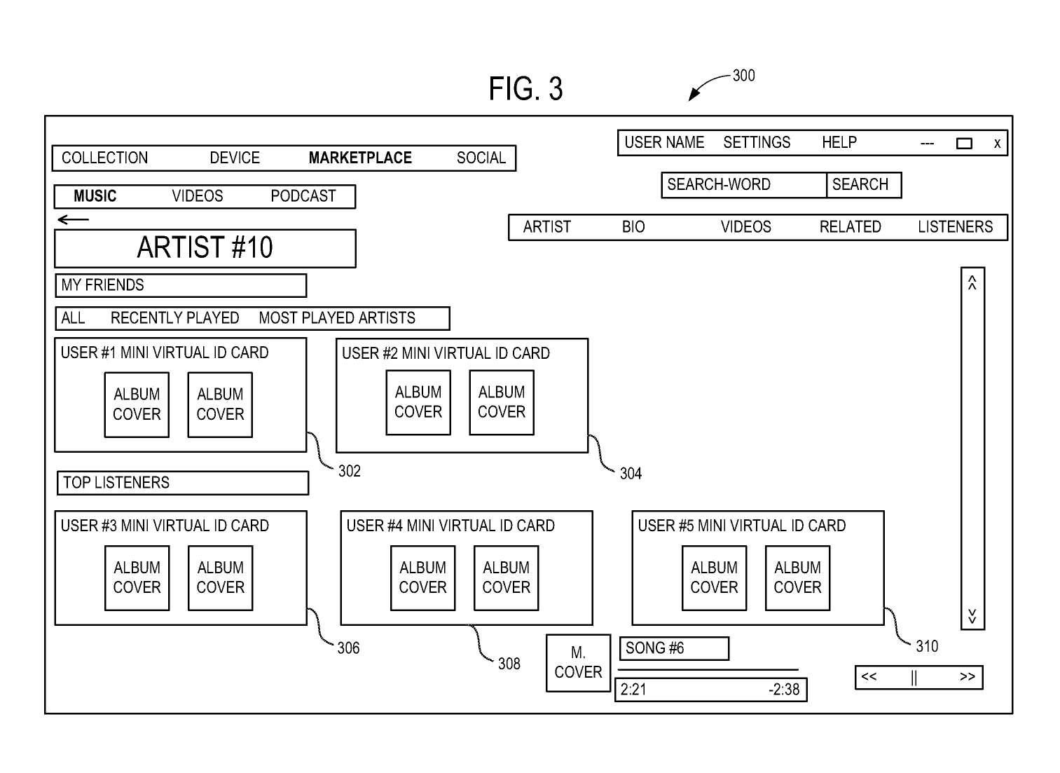

If selection of the friend link 214 is received, a screen of a graphical user interface, such as screen 300 illustrated in FIG. 3, may be presented to the user. The screen 300 may display mini virtual identity-cards of one or more user-confirmed friends (e.g., mini virtual-identity card 302 and mini virtual-identity card 304) and mini virtual-identity cards of one or more unconfirmed users (e.g., mini virtual-identity card 306, mini virtual-identity card 308, and mini virtual-identity card 310). In some embodiments, unconfirmed users with top usage histories (e.g., highest play-count for selected song or artist) will be presented.

The user-confirmed friends indicated in the mini virtual-identity cards (e.g., mini virtual-identity card 302 and mini virtual-identity card 304) may be included in a network-accessible social directory for the user. Further, for each user-confirmed friend, one or more other digital content items with which the user-confirmed friend has a usage history may be identified. For example, as in FIG. 3, User #1's mini virtual-identity card 302 may display one or more album covers of artists to which User #1 has recently listened. In the illustrated embodiment, two album covers are shown.

Further, for each such digital content item associated with a user-confirmed friend, the digital content item may be available for acquisition via a network-accessible virtual storefront, for example by purchase, download, and/or subscription. Thus, it may be appreciated that, in one example, the user may be presented with the screen 300 of a network-accessible virtual storefront, such as that illustrated in FIG. 3. Such tight integration between a network-accessible virtual storefront, a network-accessible social directory, and a digital content library is thought to greatly enhance the user experience and facilitate the browsing and shopping experiences for a user.

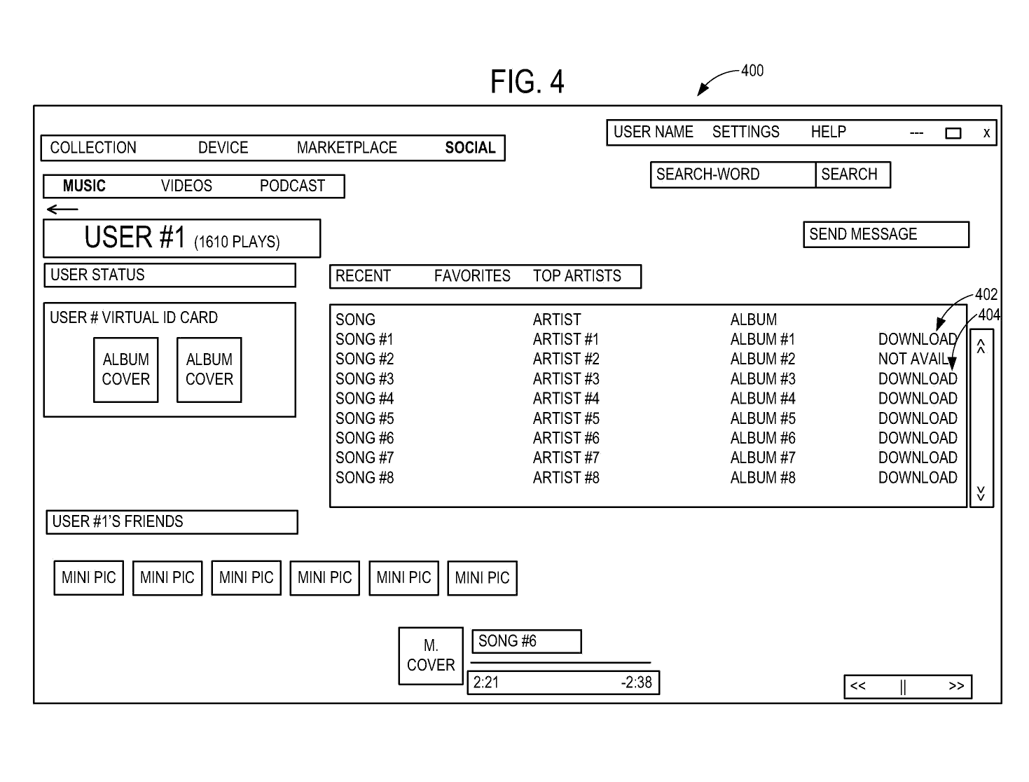

Further still, the selection of a user-confirmed friend's mini virtual-identity card (e.g., virtual-identity card 302) may direct the user to a screen of a graphical user interface including a more detailed virtual-identity card of the user-confirmed friend, as is described with respect to FIG. 4.

FIG. 4 shows a non-limiting example screen 400 of a graphical user interface displaying the virtual-identity card for one of a user's user-confirmed friends. In one example, this may be presented as a screen illustrating a network-accessible social directory. In one example, the screen 400 including the virtual-identity card for a user-confirmed friend may include one or more acquisition links (e.g., acquisition link 402 and acquisition link 404) that provide purchase access to one or more digital content items with which that user-confirmed friend has a usage history. For example, if selection of the acquisition link 402 associated with the digital content item titled “Song #1” by “Artist #1” is received, the user may be offered the option to complete purchase of the song. This interface may also be used to present virtual-identity cards for unconfirmed profiles.

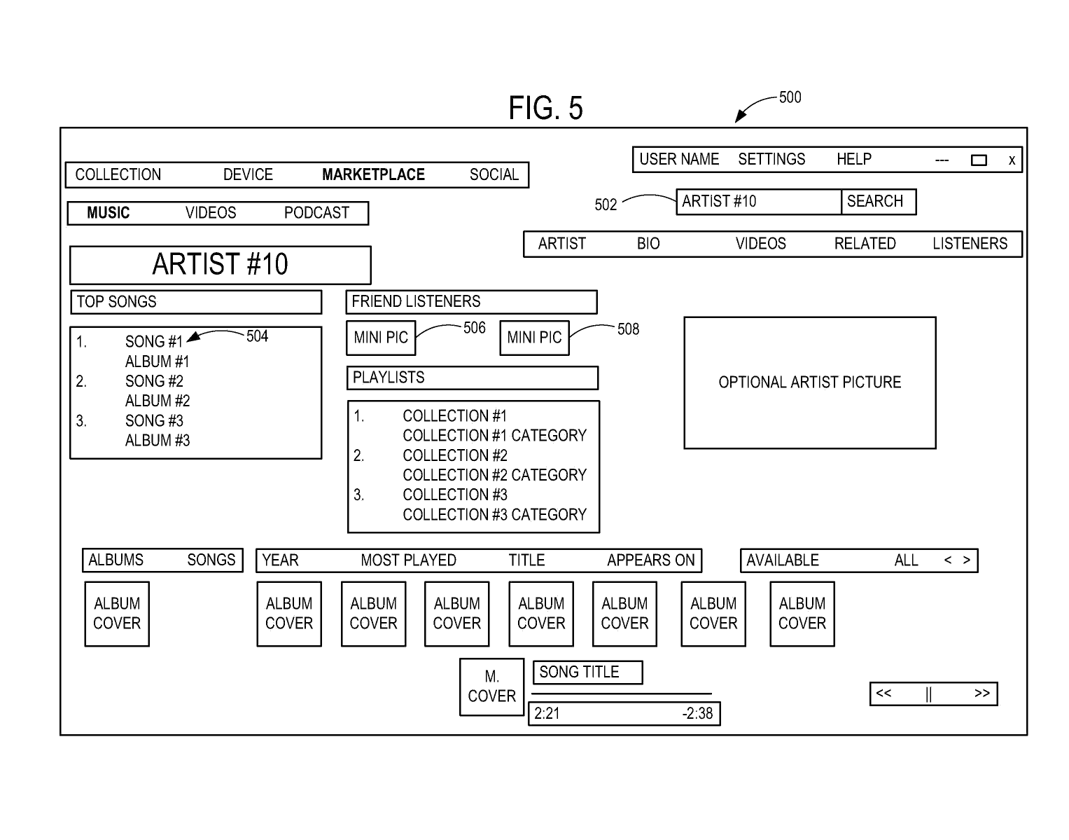

As illustrated in FIG. 5, another example of a screen 500 of a graphical user interface illustrating a network-accessible virtual storefront may be presented when a search-word indicating a particular artist name (e.g., “Artist #10”) is received in the search pane 502. The screen 500 illustrating a network-accessible virtual storefront may offer a plurality of digital content items available for acquisition. In one example, the screen 500 may offer a plurality of digital content items (e.g., albums, songs) related to Artist #10 for sale or for rent, as some examples. A network-accessible virtual storefront may sell, rent, offer subscription and/or preview a digital content item to a user.

Further, a network-accessible virtual storefront may identify one or more user-confirmed friends and/or unconfirmed users having a usage history (including a top usage history) with digital content items related to the search-word entered in the search pane 502 and/or digital content items found when browsing artists, genres, or the like. For example, if the search-word is “Artist #10”, as illustrated in FIG. 5, a network-accessible virtual storefront may identify, as in this example, two user-confirmed friends. In another example, a selection of the song link 504 titled “Song #1” may be received and a network-accessible virtual storefront may identify one or more user-confirmed friends and/or unconfirmed users having a usage history (including a top usage history) with the digital content item titled “Song #1”. In some embodiments, this may be enabled for one or more of artists, albums, songs, playlists, and virtually any other category.

Upon identification of user-confirmed friends and/or unconfirmed users, a network-accessible virtual storefront may present friend picture links (e.g., friend picture link 506 and friend picture link 508) to the virtual-identity cards for the user-confirmed friends. The friend picture link 506 and friend picture link 508 may further include purchase access to one or more of the digital content items with which the user-confirmed friend has a usage history. That is, in one example, if the friend picture link 506 is selected, a screen displaying the user-confirmed friend's virtual-identity card (e.g., screen 400 in FIG. 4) may be presented. Here, the option to purchase digital content items of the user-confirmed friend's digital content library from a network-accessible virtual storefront may be presented.

It may be appreciated that the exemplary screens of a graphical user interface described herein may present any of a digital content library, a network-accessible virtual storefront, and a network-accessible social directory of the software package. Further, the example integrations between these components as explained above are provided as non-limiting examples. Because the digital content library, network-accessible virtual storefront, and network-accessible social directory are tightly integrated into a common software package and/or network service, integrations between the various components can be customized as desired.

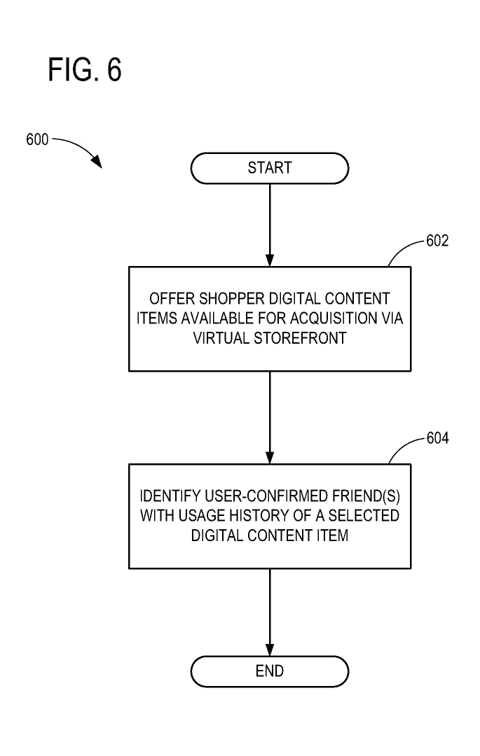

FIG. 6 shows an example method 600 of selling or renting digital content to a shopper. At 602, the method 600 includes offering to the shopper a plurality of digital content items available for acquisition via a network-accessible virtual storefront. At 604, the method 600 further includes identifying, for a digital content item selected within a network-accessible virtual storefront, one or more shopper-confirmed friends having a usage history with the selected digital content item. The scenarios described above with reference to FIGS. 2-5 provide non-limiting examples of how method 600 may be implemented.

For example, several Artist #10 albums may be offered in a network-accessible virtual storefront from which one album selection may be received. Further, in one example, a digital content management system may identify one or more user-confirmed friends with a usage history of the selected Artist #10 album, and thus may present options such that the user may directly access and/or acquire further digital content related to the user-confirmed friends.

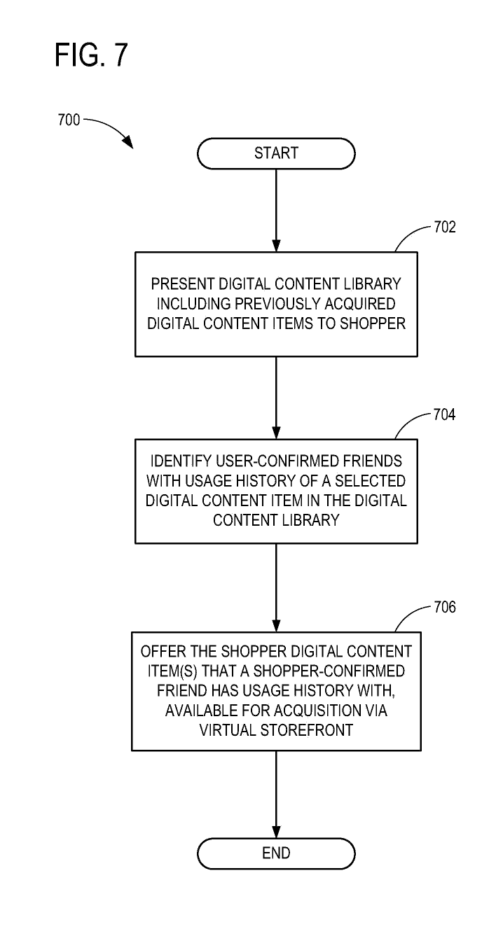

FIG. 7 shows an example method 700 of selling or renting digital content to a shopper. At 702, the method 700 includes presenting to the shopper a digital content library including a plurality of digital content items previously acquired. At 704, the method 700 further includes identifying, for a digital content item selected within a digital content library, one or more shopper-confirmed friends having a usage history with the selected digital content item. At 706, the method 700 includes offering to the shopper one or more other digital content items with which a shopper-confirmed friend has a usage history, each such other digital content item available for acquisition via a network-accessible virtual storefront. The scenarios described above with reference to FIGS. 2-5 provide non-limiting examples of how method 700 may be implemented.

For example, the user may be presented with a digital content library including several songs and albums. If the user selects a song selection link associated with a digital content item within a digital content library, for example a song “Song #1” by an artist “Artist #1”, a digital content management system may identify, in one example, user-confirmed friends with usage history of the digital content item. For example, the digital content item may include the song “Song #1” and/or digital content items associated with the artist “Artist #1”. Further, digital content items with which the user-confirmed friends have usage history may be offered to the user and these items may be available for acquisition via a network-accessible virtual storefront. For example, if a user-confirmed friend has usage history with a digital content item such as a song titled “Song #3” by “Artist #3”, the digital content item including “Song #3” and/or digital content items associated with “Artist #3” may be offered to the user for acquisition.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of selling or renting digital content to a shopper, the method comprising:
offering to the shopper a plurality of digital content items available for acquisition via a network-accessible virtual storefront; and
identifying, for a digital content item selected within the network-accessible virtual storefront, one or more shopper-confirmed friends having a usage history with that selected digital content item.

2. The method of claim 1, where the one or more shopper-confirmed friends are included in a network-accessible social directory for the shopper, the network-accessible social directory and the network-accessible virtual storefront being protected by a shared identity-verification module.

3. The method of claim 2, where the network-accessible virtual storefront and the network-accessible social directory are accessible via a same locally executed set of instructions configured to present a shared graphical user interface.

4. The method of claim 1, where the one or more shopper-confirmed friends are included in a network-accessible social directory for the shopper, the network-accessible social directory configured to identify, for each shopper-confirmed friend, one or more other digital content items with which that shopper-confirmed friend has a usage history, each such other digital content item available for acquisition via the network-accessible virtual storefront.

5. The method of claim 1, further comprising identifying, for a digital content item selected within the network-accessible virtual storefront, one or more unconfirmed users having a usage history with that selected digital content item.

6. The method of claim 1, further comprising selling a digital content item to the shopper via the network-accessible virtual storefront.

7. The method of claim 1, further comprising renting a digital content item to the shopper via the network-accessible virtual storefront.

8. A method of selling or renting digital content to a shopper, the method comprising:
presenting to the shopper a digital content library including a plurality of digital content items previously acquired;
identifying, for a digital content item selected within the digital content library, one or more shopper-confirmed friends having a usage history with that selected digital content item; and
offering to the shopper one or more other digital content items with which a shopper-confirmed friend has a usage history, each such other digital content item available for acquisition via a network-accessible virtual storefront.

9. The method of claim 8, where the network-accessible virtual storefront and the digital content library are accessible via a same locally executed set of instructions configured to present a shared graphical user interface.

10. The method of claim 8, where the one or more shopper-confirmed friends are included in a network-accessible social directory for the shopper, the network-accessible social directory and the network-accessible virtual storefront being protected by a shared identity-verification module.

11. The method of claim 10, where the network-accessible virtual storefront, the digital content library, and the network-accessible social directory are accessible via a same locally executed set of instructions configured to present a shared graphical user interface.

12. The method of claim 8, where identifying one or more shopper-confirmed friends having a usage history with that selected digital content item includes presenting a link that provides access to virtual-identity cards for such shopper-confirmed friends.

13. The method of claim 8, where a virtual-identity card for a shopper-confirmed friend includes a link that provides purchase access to one or more digital content items with which that shopper-confirmed friend has a usage history.

14. The method of claim 8, further comprising selling a digital content item to the shopper via the network-accessible virtual storefront.

15. The method of claim 8, further comprising renting a digital content item to the shopper via the network-accessible virtual storefront.

16. A digital content management system, comprising:
a digital content library including a plurality of digital content items previously acquired;
a network-accessible virtual storefront including a plurality of digital content items available for acquisition; and
a network-accessible social directory including a plurality of user-confirmed friends; and
an identity-verification module limiting acquisition access to the network-accessible virtual storefront and directory access to the network-accessible social directory contingent on verification of a common credential.

17. The digital content management system of claim 16, where the digital content library identifies, for a digital content item selected within the digital content library, one or more user-confirmed friends having a usage history with that selected digital content item.

18. The digital content management system of claim 16, where the network-accessible virtual storefront identifies, for a digital content item selected within the network-accessible virtual storefront, one or more user-confirmed friends having a usage history with that selected digital content item.

19. The digital content management system of claim 16, where the network-accessible virtual storefront identifies, for a digital content item selected within the network-accessible virtual storefront, one or more unconfirmed users having a usage history with that selected digital content item.

20. The digital content management system of claim 16, where the digital content library includes a plurality of locally-saved digital content items.
